(19) United States
(12) Patent Application Publication
(10) Pub. No.: US 2002/0013819 A1
(43) Pub. Date: Jan. 31, 2002

(54) Internet remote controller and controlling method for home appliances using the same

(76) Inventors: Hyong-Taek Lim, Seoul (KR); Yin-Young Hwang, Anyang (KR); Joon-Hyung Park, Seoul (KR)

Correspondence Address: BIRCH, STEWART, KOLASCH & BIRCH, LLP, P.O. Box 747, Falls Church, VA, 22040-0747, US

(21) Appl. No.: 09/749,683

(22) Filed: Dec. 28, 2000

(30) Foreign Application Priority Data
May 4, 2000 (KR) 23989/2000

(51) Int. Cl. G06F 15/16

(52) U.S. Cl. 709/208; 709/218

(57) ABSTRACT

The present invention relates to an internet remote controller and controlling method for home appliances using the same, which is capable of receiving needed information from a web-site through the internet and adapting the Information easily without any additional apparatus to home appliances such as a cooking apparatus which has a large bulk and is hard to transfer. The present invention comprises a transmission/reception unit interfaced with a personal computer connected to the internet and having a data output device in order to transmit or receive data according to control of a control unit, and the control unit for controlling a control object to be controlled or the personal computer in order to transmit/receive selectively a control command or data according to operation of a switch.

### BACKGROUND OF THE INVENTION

1 Field of the Invention

The present invention relates to an internet remote controller for connecting an electric home appliances to the internet, in particular to an internet remote controller and controlling method of device using the same, which is capable of receiving needed information from a web-site through the internet and adapting the information easily without any additional apparatus to an electric home appliances such as a cooking apparatus which has a large bulk and is hard to transfer.

2. Description of the Prior Art

In these days, people live conveniently more than any other times by making a lot of appliances for giving conveniences to human lives with striking development of an electronic technology, in particular developing speed in electric home appliances and communication field is outstanding by the advent of the internet.

Likewise, developing in the electric home appliances and communication field not only means making a new product but also means betterment of the conventional product in order to use more efficiently, and co-ownership of information is possible all over the world by using the internet.

In addition, it is possible to provide a new information communication service such as a bidirectional communication owing to a connection easiness by using a broadcasting network and a communication network commonly with the introduction of a computer technology, and combination among a communication appliances and a personal computer and electric home appliances has been proceeded.

In the meantime, a microwave oven having a shorter history than that of a television set, which renovated a dietary life, is invented for reducing the cooking time in a versatile modern society. In the present time, various foods cookable by the microwave oven are developed, and its cooking range expands gradually.

As described above, according to the expansion of the cooking range of the cooking apparatus, the list of cookable foodstuff is displayed on the front surface of the microwave oven as a switch type for cooking the food corresponding to press of the pertinent button, in this case the construction of the cooking device can be complicated and it is difficult to follow the increase rate of the cookable food, accordingly the cooking contents are displayed on a LCD panel in accordance with types of cooking apparatus or a cooking apparatus displays merely typical cooking foods and simple time adjusting switch.

However, such method has problems below. First, as the more specialized cooking information is involved in the apparatus, the usage is more complicated and it is difficult to get an up-grade of system, accordingly it is hard to adapt a new cooking method to the cooking apparatus. Second, as the cooking apparatus is simplified, it is difficult to perform adjusting of oven in accordance with various foods, accordingly it is impossible to perform delicious cooking.

However, for the present the above-mentioned products are slight, but it looks over function region of different appliances besides the its conventional functions by combining and intellectualizing mutually communication and network technology.

For example, the television set used to output unilaterally an image transmitted from a broadcasting station can perform bilateral communication with a receiver by a communication port and an information input/output device, as depicted in FIG.1, cooking device such as the microwave oven can solve about-mentioned problems by accepting demands above.

In other words, it can be described in more detail with reference to accompanying FIG. 1.

First, the present invention comprises a personal computer 1 for downloading required information from various information providing companies connected through the internet, a cooking apparatus 2 for cooking foods, and a transmission device 3 for loading the required cooking information to the cooking apparatus 2 by connecting the personal computer 1 and cooking apparatus 2 through a communication line.

Hereinafter, the operation of the apparatus according to the present invention will now be described.

First, the cooking apparatus 2 can download the required cooking information from the personal computer 1 through the transmission device 3 performing a serial communication by a RS-232C at any time, the personal computer 1 receives and stores the cooking information provided from the professional cooking company, when a user needs it, the user can search the cooking information and perform the cooking by loading the information to the cooking apparatus 2 through the transmission device 3.

In other words, the cooking apparatus 2 only comprises a simple adjustment switch, the detailed cooking information according to the food kind is loaded from the personal computer 1 in case of need, accordingly said apparatus is simple to use in normal times and it can also satisfy the various cooking request of the user.

In addition, whenever new cooking information is upgraded, the personal computer downloads it automatically and stores it or transmits the pertinent information to the cooking apparatus 2 through the transmission device 3 by connecting directly to the web-site (home page) of the professional cooking company, because the personal computer 1 is connected to the internet network,

Herein, the transmission device 3 can be embodied as an outer packaging or can be embodied as a built-in type of the cooking apparatus 2.

However, as described above, the conventional transmission device is not good for the appearance and it is annoying to perform the wiring because the transmission device independently connects to the personal computer, downloads the information, stores it, again connects to the cooking apparatus, and transmits the information to the cooking apparatus as a information storing mean and a communication mean or it is embodied as a built-in type inside of the cooking apparatus and it is connected to the personal computer by wiring.

### SUMMARY OF THE INVENTION

In order to solve above-mentioned problems, the object of the present invention is to provide an internet remote controller and controlling method for home appliances using the same which is capable of using easily, performing a higher function, and getting an upgrade easily with new information by downloading the information to the remote controller and transmitting the information required for controlling appliances with a control command in order to give convenience to modern people familiar with the remote controller.

In order to achieve the objects, the present invention comprises a transmission/reception unit interfaced with a personal computer connected to the internet and having a data output device in order to transmit or receive data according to control of a control unit, and the control unit for controlling a control object to be controlled or the personal computer in order to transmit/receive selectively a control order or data according to operation of a switch.

In addition, controlling method for appliances by using the internet remote controller according to the present invention comprises a downloading step for downloading the required data from an information providing company through a personal computer connected to the internet, a receiving step for receiving and storing the required data on an internet remote controller by connecting directly or remote-connecting to the personal computer, and a transmitting step for transmitting the stored data and control commands of home appliances to the corresponding control apparatus to be controlled.

### BRIEF DESCRIPTION OF THE DRAWINGS

FIG. 1 illustrates a construction for describing a control method of home appliances according to the conventional control information transmission.

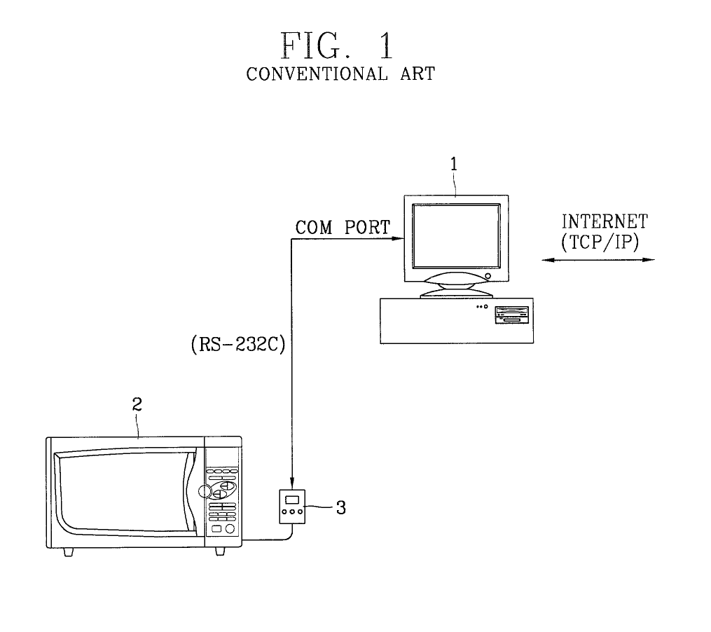

FIG.2 illustrates a construction and a using method of an internet remote controller according to the present invention.

### DETAILED DESCRIPTION OF THE PREFERRED EMBODIMENTS

Hereinafter, the embodiment of the present invention will now be described in detail with reference to accompanying drawings.

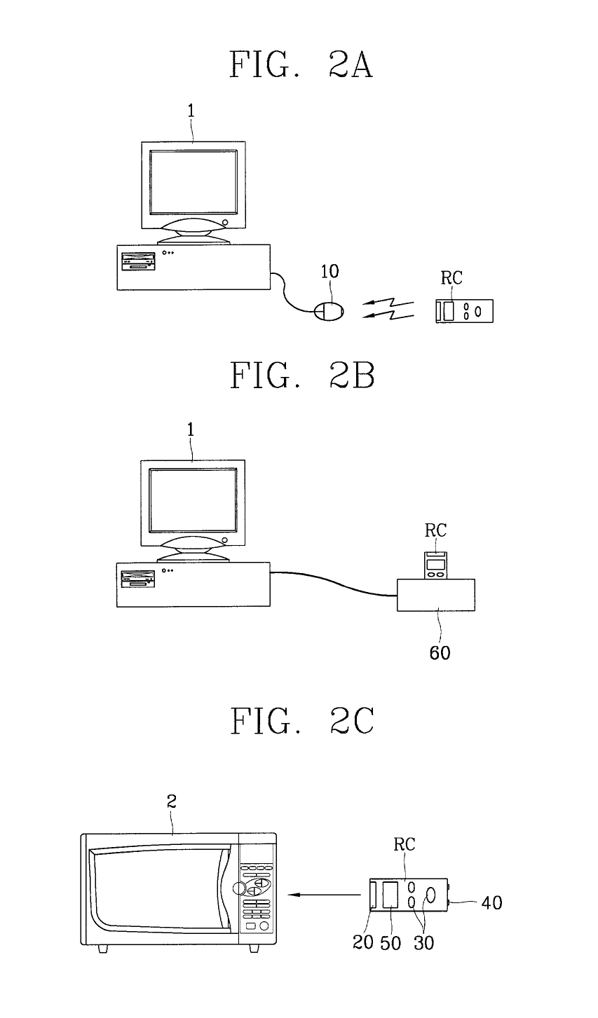

First, as depicted in FIG. 2A, in the present invention, the construction of device and operation method for the information transmission are simplified in that the function of the conventional transmission device is performed by a remote controller RC.

In other words, in FIG. 2A, a personal computer 1 comprises an output device 10 for downloading the required information from an information providing web site through the internet and for outputting it to an adapter or an infrared (IrDA) transmission device.

Next, as depicted in FIG. 2C, the remote controller RC comprises a transmission/reception unit 20, 40 for transmitting or receiving the information by interfacing with the output device 10 with different method each other, and a control unit 50 for storing the information received through the transmission/reception unit 20, 40 and for controlling it so as to transmit/receive selectively the control command or information data in accordance with the operation of the switch 30.

Hereinafter, the preferred embodiments using the controlling method of the home appliances according to the present invention will now be described.

First, in case that the output device 10 provided in the personal computer 1 has an adapter form, the information is transmitted by inserting the remote controller RC into the adapter, at that time the information is inputted through the transmission/reception unit 40 of the remote controller RC.

FIG. 2B illustrates that the remote controller is inserted into the adapter 60.

That is, after inserting the remote controller RC into the adapter 60, the information transmission command is performed by operating a keyboard (not shown) of the personal computer 1, accordingly the information data is transmitted to an object to be controlled through the transmission/reception unit 40.

In addition, in case that the output unit 10 is the infrared transmission unit, the information can be received without inserting the remote controller RC into the adapter 60, accordingly it is simple to use.

Namely, after coinciding the infrared output direction of the output unit 10 with the infrared reception direction of the remote controller RC, the information data is transmitted to the control object through the transmission/reception unit 20 on executing information transmission command by operating keyboard of the personal computer like the case of said adapter(60) after switching into the information reception mode by operating the switch 30 of the remote controller RC.

After that, when the volume of the inputted information is relatively small, it can be stored on a built-in memory of the control unit 50, when the volume of the inputted information is large, it can be stored by attaching a memory (not shown) additionally.

In this manner, when the information is stored on the remote controller RC, a user places the transmission/reception unit 20 of the remote controller RC toward the apparatus to be controlled (in the present embodiment, the cooking apparatus 2), after that when the user pushes a start switch 30, the control unit 50 detects it, and it transmits the stored information and a cooking start command together.

According to this, the cooking apparatus 2 stores the information transmitted from the remote controller RC on the built-in memory, and performs the cooking at the same time with the reception of the cooking start order according to the predetermined order.

Internet remote controller in the present invention can perform the remote-control of home appliances to be controlled, even through the cooking apparatus is far apart from the computer, accordingly the apparatus in the present invention is very convenient and is simple to use.

Of course, the cooking apparatus 2 comprises an infrared reception unit for the information reception besides a simple switch for the basic operation control, accordingly the manufacturing cost can be reduced and it can exert the high performance.

The present invention can be adapted to various electric home appliances such as a washing machine, a refrigerator, a television set, a VTR etc. as well as the cooking apparatus. In addition, when the user wants to control the contents of the electric home appliances such as the laundry, programs etc. by subdividing their operation conditions into many conditions, the structure of the apparatus can be constructed as simple as possible, and the function can be increased as many as possible.

As described above, the internet remote controller and control method of home appliances using the same according to the present invention is capable of satisfying the user's need and using easily by transmitting the required information from the web site through the internet and adapting it to the apparatus which has a large bulk and is difficult to transfer such as the cooking apparatus without a special additional apparatus. In addition, the present invention can be adapted widely to the electric home appliances such as the television sets, washing machines, refrigerators, VTR etc.

What is claimed is:

1. An internet remote controller, comprising:
a transmission/reception unit interfaced with a personal computer connected to the internet and having a data output device in order to transmit or receive data according to control of a control unit; and
the control unit for controlling to transmit/receive selectively a control command or data from a control object to be controlled or the personal computer according to operation of a switch.

2. The internet remote controller according to claim 1, wherein the transmission/reception unit is constructed so as to be interfaced by an infrared transmission/reception method when the data output device of the personal computer is constructed as the infrared transmission method.

3. The internet remote controller according to claim 1, wherein the transmission/reception unit is constructed so as to be interfaced by being inserted into an adapter when the data output unit of the personal computer is constructed as the adapter type.

4. The internet remote controller according to claim 1, wherein the transmitted/received data is the most appropriate control data in accordance with a operation time or contents state of the apparatus to be controlled.

5. The internet remote controller according to claim 1, wherein the control unit switches the transmission/reception unit into a reception mode when it receives data from the personal computer connected to the internet, and it switches the transmission/reception unit into a transmission mode when it transmits data to the apparatus to be controlled.

6. A controlling method for home appliances using an internet remote controller, comprising:
downloading the required data from an information providing company through a personal computer connected to the internet;
receiving and storing the required data on an internet remote controller by connecting directly or remote-connecting to the personal computer; and
transmitting the stored data and control command of home appliances to the corresponding control apparatus to be controlled.

7. The controlling method for home appliances using the internet remote controller according to claim 6, wherein the transmitted/received data is the information which is downloaded and is stored from the web site for providing the information through the internet.
